(19) United States
(12) Patent Application Publication
(10) Pub. No.: US 2023/0394389 A1
(43) Pub. Date: Dec. 7, 2023

(54) PLATFORM FOR MANAGING TASKS RELATED TO SERVICE REQUESTS FOR VEHICLE

(71) Applicant: Honda Motor Co., Ltd., Tokyo (JP)

(72) Inventors: GEETHANJALI ANAND, Chicago, IL (US); DANY COTERO, Evanston, IL (US); SANTIAGO ANDRES VALDES GONZALEZ, Evanston, IL (US); ADITYA MAHAJAN, Evanston, IL (US)

(21) Appl. No.: 17/833,740

(22) Filed: Jun. 6, 2022

(51) Int. Cl. G06Q 10/06

(52) U.S. Cl. CPC G06Q 10/06311

(57) ABSTRACT

An electronic device and method for managing tasks related to service requests for a vehicle is provided. The electronic device receives a service request associated with a vehicle and determines a location where a primary task of the service request is executable, based on the service request. The electronic device identifies a pool of workers for fulfilment of the service request, based on the location and assigns a first worker to move the vehicle to the location and a second worker to execute the primary task at the location. The electronic device collects operational information associated with the vehicle based on execution and generates a trigger event that indicates completion of the primary task, based on the operational information. The display device is controlled to display a service request status based on the operational information and the trigger event.

### BACKGROUND

Advancements in delivery of vehicle-related services have led to the development of various techniques for availing various vehicle-related services from service providers. Typically, workers with specific skills may provide their services (for example, vehicle charging, battery replacement, component repair, and so on) via one or more service providers. A vehicle user may request for a vehicle-related service via a service provider or the vehicle user may directly request workers for services. The vehicle-related service may include tasks and execution of each task may depend on completion of a previous task. Typically, tasks may be executed in silo and the user may have to separately manage the booking of each task and track the execution of each task. Efficient fulfilment of the vehicle-related service may require an efficient resource planning. Without such planning, the user may experience unforeseen delays or may have to accept denials from workers that are selected to execute certain tasks. This may impact the trust of the user in services of the workers and/or the service provider.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to an embodiment of the disclosure, an electronic device configured to manage tasks related to service requests for a vehicle via a platform is provided. The electronic device may include circuitry that may receive a service request associated with a vehicle and may determine a location where a primary task of the service request is executable, based on the service request. The primary task may be associated with an operational requirement of the vehicle. The circuitry may identify a pool of workers available for fulfilment of the service request, based on the determined location and may assign a first worker from the pool of workers to move the vehicle from an initial location to the determined location. While the vehicle is at the determined location, the circuitry may further assign a second worker from the pool of workers to execute the primary task. The circuitry may collect operational information associated with the vehicle based on the execution of the primary task and may generate a trigger event that indicates a completion of the primary task, based on the operational information. The circuitry may control a display device to display a status of the service request, based on the collected operational information and the trigger event.

According to another embodiment of the disclosure, a method for managing tasks related to service requests for a vehicle via a platform is provided. The method may include receiving a service request associated with a vehicle. The method may further include determining, based on the service request, a location where a primary task of the service request is executable. The primary task may be associated with an operational requirement of the vehicle. The method may further include identifying a pool of workers that is available for a fulfilment of the service request, based on the determined location. The method may further include assigning a first worker from the pool of workers to move the vehicle from an initial location to the determined location. The method may further include assigning a second worker from the pool of workers to execute the primary task while the vehicle is at the determined location. The method may further include collecting operational information associated with the vehicle, based on the execution of the primary task. The method may further include generating, based on the operational information, a trigger event that indicates a completion of the primary task. The method may further include controlling a display device to display a status of the service request, wherein the status is displayed based on the collected operational information and the trigger event.

According to another embodiment of the disclosure, a non-transitory computer-readable medium is provided. The non-transitory computer-readable medium may have stored thereon computer implemented instructions that, when executed by an electronic device, causes the electronic device to execute operations. The operations may include receiving a service request associated with a vehicle. The operations may further include determining, based on the service request, a location where a primary task of the service request is executable. The primary task may be associated with an operational requirement of the vehicle. The operations may further include identifying a pool of workers that is available for a fulfilment of the service request, based on the determined location. The operations may further include assigning a first worker from the pool of workers to move the vehicle from an initial location to the determined location. The operations may further include assigning a second worker from the pool of workers to execute the primary task while the vehicle is at the determined location. The operations may further include collecting operational information associated with the vehicle, based on the execution of the primary task. The operations may further include generating, based on the operational information, a trigger event that indicates a completion of the primary task. The operations may further include controlling a display device to display a status of the service request, wherein the status is displayed based on the collected operational information and the trigger event.

### BRIEF DESCRIPTION OF THE DRAWINGS

FIG. 1 is a block diagram that illustrates an exemplary network environment for management of tasks related to service requests for a vehicle, in accordance with an embodiment of the disclosure.

FIG. 2 is a block diagram that illustrates an exemplary electronic device that serves as a platform for management of tasks related to service requests for a vehicle, in accordance with an embodiment of the disclosure.

FIG. 3 is an exemplary scenario diagram that illustrates a user device that is controlled by an electronic device to display an option to transmit a service request for a vehicle, in accordance with an embodiment of the disclosure.

FIG. 4 is a flowchart that illustrates exemplary operations for management of tasks related to service requests for a vehicle by an electronic device, in accordance with an embodiment of the disclosure.

FIG. 5A is an exemplary scenario diagram that illustrates transmission of status of a service request associated with charging of a battery unit of an electric vehicle, in accordance with an embodiment of the disclosure.

FIG. 5B is an exemplary scenario diagram that illustrates display of stepwise status of a service request associated with charging of a battery unit of an electric vehicle, in accordance with an embodiment of the disclosure.

FIG. 6A is an exemplary scenario diagram that illustrates transmission of status of a service request associated with swapping or replacing a discharged battery unit of an electric vehicle, in accordance with an embodiment of the disclosure.

FIG. 6B is an exemplary scenario diagram that illustrates display of stepwise status of a service request associated with swapping or replacing a discharged battery unit of an electric vehicle, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The following described implementations may be found in the disclosed electronic device and method for management of tasks related to service requests for a vehicle. Exemplary aspects of the disclosure may provide an electronic device (such as a server) that may be configured to receive a service request associated with a vehicle (such as a fossil-fuel powered vehicle, an electric vehicle, or a hybrid vehicle). The electronic device may determine, based on the service request, a location (e.g., a charging station or a vehicle refueling station) where a primary task (such as a charging an electric vehicle) of the service request may be executable. The primary task may be associated with an operational requirement of the vehicle. The electronic device may identify a pool of workers available for fulfilment of the service request, based on the determined location and may assign a worker from the pool of workers to move the vehicle from an initial location (such as premises of an owner of the vehicle) to the determined location. The electronic device may also assign a worker from the pool of workers to execute the primary task while the vehicle is at the determined location. Throughout the duration for which the primary task is executed, the electronic device may collect operational information (such as a state of charge of the vehicle or an operational state of a component of the vehicle) associated with the vehicle. Based on the operational information, the electronic device may generate a trigger event that indicates a completion of the primary task. A display device (such as a smart phone, a wearable device, or a device having a display) may be controlled to display a status (such as a completion of the primary task) of the service request. The status may be displayed based on the collected operational information and the trigger event.

Conventionally, service providers provide vehicle-based services where each task related to a vehicle-based service may be executed in a silo. A user may have to search for a worker and book a visit by the worker for execution of a task. The user may have to also track execution of the task if the user is not at the location where the task is executed. In some instances, there may be tasks that require multiple workers, and the user may find it difficult to schedule and track execution of each task. In some cases, the workers may not be available at a desired time or a desired location, or the worker may not have the right skill to execute a task. In some other instances, there may be unforeseen delays due to unavailability of a worker or a denial from a worker (who may have previously agreed to execute a task).

To address all such issues, the disclosed electronic device may provide a digital platform (e.g., a server) that allows a user to avail different types of services associated with a vehicle, via a single service request to the electronic device. The service request may indicate an objective related to a vehicle that needs to be achieved to meet operational requirements of the vehicle. The digital platform may allocate workers (e.g., gig workers) that may be related to a vehicle (e.g., an Electric Vehicle). As an example, a valet service may be provided which allows a worker to enter their credentials. The worker, through an application, may enter information that may indicate their availability for work. The worker may go to a location to find the vehicle that the owner has requested to be charged. The worker may pick up the vehicle from the location and may drive the vehicle to a charging location. In each step of the way, the owner may be able to track the progress of the work through a user interface. The platform may establish a gig economy and the same worker may not have to charge or return the vehicle. In some instances, the platform may allocate another worker to charge or return the vehicle to the owner. Before a worker may drive the vehicle to a location, the platform may automatically set up the vehicle for a return based on the SOC of the vehicle. Thus, the platform may coordinate with other workers in the area, based on a time when the vehicle completes the charging.

Reference will now be made in detail to specific aspects or features, examples of which are illustrated in the accompanying drawings. Wherever possible, corresponding, or similar reference numbers will be used throughout the drawings to refer to the same or corresponding parts.

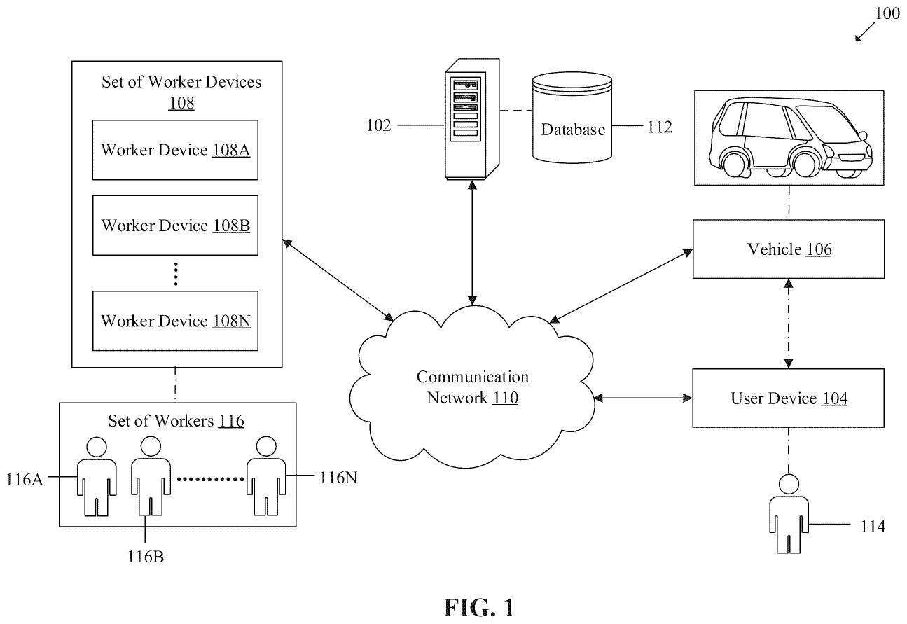

FIG. 1 is a block diagram that illustrates an exemplary network environment for management of tasks related to service requests for a vehicle, in accordance with an embodiment of the disclosure. With reference to FIG. 1, there is shown a network environment 100. The network environment 100 may include an electronic device 102, a user device 104, a vehicle 106, and a set of worker devices 108. The electronic device 102 may communicate with the user device 104, the vehicle 106, and each worker device of the set of worker devices 108, through a communication network 110. The electronic device may include a database 112. The set of worker devices 108 may include a first worker device 108A, a second worker device 108B, . . . and a N^{th} worker device 108N. In some embodiments, the user device 104 may be coupled to the vehicle 106.

In FIG. 1, there is further shown a user 114 who may be associated with the user device 104 and the vehicle 106. Also, there is further shown a set of workers 116 associated with the set of worker devices 108. The set of workers 116 may include a first worker 116A, a second worker 1166, . . . and a N^{th} worker 116N. The first worker 116A may be associated with the first worker device 108A. Similarly, the second worker 116B may be associated with the second worker device 1086 and the N^{th} worker 116N may be associated with the Nth worker device 108N. The number of worker devices and the number of workers shown in FIG. 1 are presented merely as an example and such an example should not be construed as limiting the disclosure.

The electronic device 102 may include suitable logic, circuitry, interfaces, and/or code that may be configured to manage assignment and fulfilment of tasks related to a service request for a vehicle (such as the vehicle 106). The service request may be initiated by the electronic device 102 or by the user device 104. In accordance with an embodiment, the electronic device 102 may be a server, an edge device, or a distributed ledger (such as a Blockchain ledger). The electronic device 102 may execute operations through web applications, cloud applications, HTTP requests, repository operations, file transfer, and the like. Example implementations of the electronic device 102 may include, but are not limited to, a database server, a web server, an application server, a mainframe server, a cloud computing server, or a combination thereof. In at least one embodiment, the electronic device 102 may be implemented as a plurality of distributed compute-resources by use of several technologies that are well known to those ordinarily skilled in the art.

The user device 104 may include suitable logic, circuitry, interfaces, and/or code that may be configured to receive a user input from the user 114. The user input may be indicative of a service request associated with the vehicle 106. The user device 104 may be configured to transmit the service request to the electronic device 102 based on the user input. The user device 104 may be also configured to display a stepwise status of the service request based on inputs received from the electronic device 102. Examples of the user device 104 may include, but are not limited to, a monitor, a television, a computing device, a desktop, a personal computer, a laptop, a computer workstation, a tablet computing device, a smartphone, a cellular phone, a mobile phone, a consumer electronic (CE) device having a display, an Internet of Things (IoT) device, a wearable display, or a head mounted display.

The user device 104 may further include an I/O device that may be configured to receive an input and provide an output based on the received input. The I/O device may include one or more input or output devices that may communicate with different components of the user device 104. For example, the I/O device may receive user inputs from the user 114 to transmit a service request. Examples of the I/O device may include, but are not limited to, a touch screen, a keyboard, a mouse, a joystick, a microphone, a display device coupled to the user device 104, and a speaker. The touch screen may be at least one of a resistive touch screen, a capacitive touch screen, or a thermal touch screen. The I/O device may further include a display device. The display device may be configured to receive inputs from the electronic device 102 to display, on a display screen, an option to transmit a service request and a status of the service request received from the electronic device 102. The display device or the display screen may be realized through several known technologies such as, but not limited to, at least one of a Liquid Crystal Display (LCD) display, a Light Emitting Diode (LED) display, a plasma display, or an Organic LED (OLED) display technology, or other display devices.

The vehicle 106 may include suitable logic, circuitry, and interfaces that may be configured to monitor one or more parameters (such as a State of Charge (SOC) of the vehicle 106, a fuel level of the vehicle 106, or a state of operation of one or more components of the vehicle 106) associated with operational requirements of the vehicle 106. Such parameters may correspond to operational information of the vehicle 106.

The vehicle 106 may include one or more sensors to determine operational information associated with the operational requirements of the vehicle 106. The vehicle 106 may be configured to periodically transmit such operational information to the electronic device 102 or the user device 104. The vehicle 106 may be a non-autonomous vehicle, a semi-autonomous vehicle, or a fully autonomous vehicle, for example, as defined by National Highway Traffic Safety Administration (NHTSA). Examples of the vehicle 106 may include, but are not limited to, a e-kick scooter, a personal transporter, an electric scooter, an electric unicycle, an electric bicycle, an electric hover board, an electric skateboard, a roller skate, a compact four-wheeler vehicle, a compact three-wheeler vehicle, a two-wheeler vehicle, a wheelchair with an actuator-based driving unit, a hybrid vehicle, or a vehicle with autonomous drive capability that uses one or more distinct renewable or non-renewable power sources. A vehicle that uses renewable or non-renewable power sources may include a fossil fuel-based vehicle, an electric propulsion-based vehicle, a hydrogen fuel-based vehicle, a solar-powered vehicle, and/or a vehicle powered by other forms of alternative energy sources. Examples of the compact four-wheeler vehicle may include, but are not limited to, an electric car, an internal combustion engine (ICE)-based car, a fuel-cell based car, a solar powered-car, or a hybrid car. Similarly, examples of the two-wheeler vehicle may include, but are not limited to, an electric two-wheeler, an internal combustion engine (ICE)-based two-wheeler, or a hybrid two-wheeler. The description of other types of the vehicles has been omitted from the disclosure for the sake of brevity.

In accordance with an embodiment, the vehicle 106 may include a location sensor that may be configured to determine a current geo-location of the vehicle 106. Examples of the location sensor may include, but are not limited to, a Global Navigation Satellite System (GNSS)-based sensor of the vehicle 106. Examples of the GNSS-based sensor may include, but are not limited to, global positioning sensor (GPS), Global Navigation Satellite System (GLONASS), or other regional navigation systems or sensors. In accordance with another embodiment, the vehicle 106 may be connected to one or more wireless network that provide information related to the current geo-location of the vehicle 106. For example, the wireless network may be a cellular-V2X (Vehicle-to-Everything) network, or a network based on DSRC (Dedicated short-range communication) protocol.

In accordance with an embodiment, the vehicle 106 may include a network interface that may be configured to facilitate communication with the electronic device 102 or the user device 104, via the communication network 110, to transmit the operational information and location of the vehicle 106. The network interface may be implemented by use of various known technologies to support wired or wireless communication of the vehicle 106 with the communication network 110. The network interface may include, but is not limited to, an antenna, a RF transceiver, one or more amplifiers, a tuner, one or more oscillators, a digital signal processor, a CODEC chipset, a SIM card, or a local buffer circuitry. The network interface may be configured to communicate via wireless communication with networks, such as the Internet, an Intranet, or a wireless network, such as a cellular telephone network, a wireless LAN, and a MAN. The wireless communication may be configured to use one or more of a plurality of communication standards, protocols, and technologies, such as GSM, EDGE, W-CDMA, LTE, 5G NR, CDMA, TDMA, Bluetooth, Wi-Fi (such as IEEE 802.11a, IEEE 802.11b, IEEE 802.11g or IEEE 802.11n), VoIP, Li-Fi, Wi-MAX, a protocol for email, instant messaging, and a SMS.

In accordance with an embodiment, the vehicle 106 may include a battery unit which may be a source of electric power for one or more electric circuits or loads in the vehicle 106. The battery unit may be recharged by connecting the battery unit to an Electric Vehicle (EV) charger. The battery unit may also be refuellable. In some embodiments, the battery unit may correspond to a battery pack, which may one or more stacks or other arrangement of batteries surrounded by a suitable coolant system and a charge controller. Examples of the battery unit may include, but are not limited to, a lead acid battery, a nickel cadmium battery, a nickel-metal hydride battery, a lithium-ion battery, and other rechargeable batteries.

Each worker device of the set of worker devices 108 may include suitable logic, circuitry, and interfaces that may be configured to receive task alerts associated with the primary task of the service request from the electronic device 102. For example, the first worker device 108A may receive a task alert that specifies a task to move the vehicle 106 from an initial location or first location (current location of the vehicle 106) to a second location where the primary task of the service request is executable. The second worker device 108B may receive a task alert that specifies the primary task (to be executed at the second location). The third worker device 108C may receive a task alert that specifies a task to return the vehicle 106 to the first location (after the completion of the primary task). Each worker device of the set of worker devices 108 may transmit a user input indicative of either a confirmation or an acknowledgement of a task specified in the task alert to the electronic device 102. Further, each worker device of the set of worker devices 108 may transmit, to the electronic device 102, a user input indicative of a completion of the task specified in the task alert. Examples of each worker device in the set of worker devices 108 may include, but are not limited to, a computing device, a desktop, a personal computer, a laptop, a computer workstation, a tablet computing device, a smartphone, a cellular phone, a mobile phone, a CE device having a display, a TV, a wearable display, or a head mounted display.

The communication network 110 may include a communication medium through which the electronic device 102, the user device 104, the vehicle 106, and the set of worker devices 108, may communicate with each other. The communication network 110 may be one of a wired connection or a wireless connection. Examples of the communication network 110 may include, but are not limited to, the Internet, a cloud network, a Cellular or Wireless Mobile Network (such as a Long-Term Evolution and 5G New Radio), a Wireless Fidelity (Wi-Fi) network, a Personal Area Network (PAN), a Local Area Network (LAN), or a Metropolitan Area Network (MAN). Various devices in the network environment 100 may be configured to connect to the communication network 110 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

The database 112 may include suitable logic, interfaces, and/or code that may be configured to store records associated service requests of the vehicle 106. Each record may include timestamps associated with one or more of reception of a service request, identification of the pool of workers available to fulfill the service request, assignment of workers of the pool of workers to perform tasks associated with the service request, or completion of the tasks associated with the service request. The database 112 may be derived from data off a relational or non-relational database or a set of comma-separated values (csv) files stored on a conventional or a big-data storage. The database 112 may be stored or cached on a device, such as the electronic device 102. The electronic device 102 may retrieve the records to improve efficiency in the process of identification of the pool of workers for fulfillment of future service requests. Efficient identification of the pool of workers may ensure that the tasks associated with a service request are completed within allocated time with a minimum delay. In some embodiments, the database 112 may be hosted on the electronic device 102. The operations of the database 112 may be executed using hardware including a processor, a microprocessor (e.g., to perform or control performance of one or more operations), a field-programmable gate array (FPGA), or an application-specific integrated circuit (ASIC). In some other instances, the database 112 may be implemented using software.

In operation, the electronic device 102 may receive a service request from the user device 104. The service request may be associated with the vehicle 106 and may indicate operations to be performed for fulfillment of the service request. Based on the service request, the electronic device 102 may determine a first location where a primary task of the service request is executable. The primary task may be associated with an operational requirement of the vehicle 106. The operational requirement may refer to a requirement or a condition that may must be satisfied to keep the vehicle 106 in an operational state. For example, the operational requirement may specify a target range or a value of parameters, such as a State of Charge (SoC) of a battery unit of the vehicle 106, a tire pressure, a level of lubricants or coolants in the vehicle 106, or a state of critical functional components of the vehicle 106.

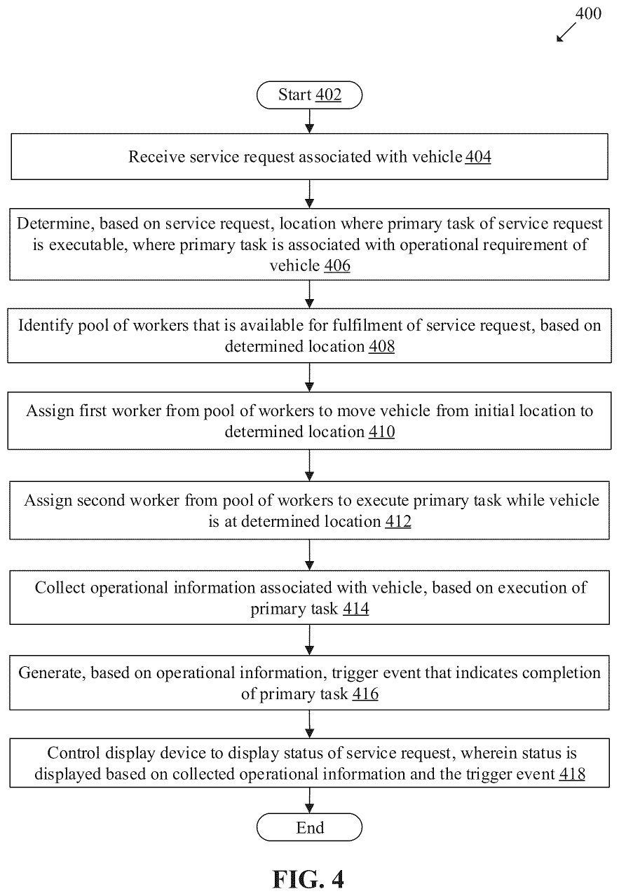

In accordance with an embodiment, the electronic device 102 may determine an operation to recharge the battery unit of the vehicle 106, as indicated in the service request. The electronic device 102 may also determine a location of a charging station where the battery unit of the vehicle 106 may be charged. The location of the charging station may be referred to as the first location. The determination of the first location may be based on an initial location of the vehicle 106 or a distance between the initial location of the vehicle 106 and the first location. Details pertaining to the determination of the location are further provided, for example, in FIG. 4.

Along with the primary task, the electronic device 102 may determine a secondary task that includes one or more operations to be performed for the fulfillment of the service request. For example, the vehicle 106 may be in a second location (e.g., initial location of the vehicle 106) which is different from the first location (i.e., a location where the primary task is executable). the vehicle 106 may be parked for example, at a garage of the user 114 at the second location. The battery charging operation (i.e., primary task) may have to be performed at a charging station (located at the first location). The secondary task may include an operation to move the vehicle 106 to the determined first location from the second location, and an operation to return the vehicle to the second location (garage of the user 114) once the battery unit of the vehicle 106 is fully charged or is charged up to a level set by the user of the vehicle 106.

The electronic device 102 may identify a pool of workers that are available for the fulfilment of the service request, based on the determined location (i.e., the first location). The pool of workers may include a plurality of workers who may be at same or different locations within a specific distance from the initial location (i.e., the second location) of the vehicle 106 or the first location where the primary task is to be performed. The electronic device 102 may select one or more workers from the pool of workers. In accordance with an embodiment, the selection of the one or more workers may be based on the capability of the one or more workers to perform the primary task and the secondary task associated with the service request. The selection may be further based on criteria such as a delay involved in a selected worker reaching the second location to pick the vehicle 106, a delay involved in bringing the vehicle 106 to the first location, or a delay involved in returning the vehicle 106 to the second location. Additionally, or alternatively, the selection may be based on a cost associated with the selected worker in travelling to the second location to pick the vehicle 106, a cost associated with the selected worker in bringing the vehicle 106 to the first location, or a cost associated with the selected worker in returning the vehicle 106 to the second location. Details pertaining to the identification of the pool of workers available for the fulfilment of the service request are further provided, for example, in FIG. 4.

The electronic device 102 may assign the first worker 116A, from the identified pool of workers, to move the vehicle 106 from an initial location (i.e., the second location) of the vehicle 106 to the determined location (i.e., the first location) for execution of the primary task. In accordance with an embodiment, the first worker 116A may be identified based on the location of the first worker 116A, the first location, the second location, and/or an availability for a job or a task. Details pertaining to the assignment of the first worker 116A to move the vehicle 106 are further provided, for example, in FIG. 4.

The electronic device 102 may further assign the second worker 116B from the identified pool of workers to execute the primary task while the vehicle 106 is at the determined location (i.e., first location). In accordance with an embodiment, prior to the assignment of the second worker 116B to execute the primary task, the second worker 116B may be identified based on a location of the second worker 116B. Once the second worker 116B is identified, the electronic device 102 may assign the second worker 116B to execute the primary task. For example, the electronic device 102 may assign the second worker 116B to execute the primary task of charging the battery unit of the vehicle 106 while the vehicle 106 is at the first location. Details pertaining to the assignment of the second worker 116B to execute the primary task are further provided, for example, in FIG. 4.

Based on the execution of the primary task, the electronic device 102 may collect operational information associated with the vehicle 106. For example, while the vehicle 106 may be connected to a charger, information including a current State of Charge (in %) of a battery unit of the vehicle 106 and a number of miles (e.g., 200 miles) that the vehicle 106 may travel at the current State of Charge (in %) may be collected as part of the operational information. The electronic device 102 may receive the operational information from the vehicle 106. In accordance with an embodiment, the operational information may be received after the execution of the primary task. For example, the electronic device 102 may collect current State of Charge (operational information) of the vehicle 106 based on execution of the operation to charge the battery unit of the vehicle 106 (primary task). The vehicle 106 may continuously monitor changes in the State of Charge level of the vehicle 106 as the battery unit of the vehicle 106 receives the charge at the determined location (i.e., first location). Based on the changes, the vehicle 106 may transmit a current State of Charge as part of the operational information to the electronic device 102.

In accordance with an embodiment, the electronic device 102 may determine a maximum travel distance that may be achievable after the battery unit of the vehicle 106 is completely charged. The distance may be transmitted as part of the operational information to the electronic device 102. Details pertaining to the collection of operational information associated with the vehicle 106, based on the execution of the primary task are further provided, for example, in FIGS. 4, 5A, and 6A.

Based on the collected operational information, the electronic device 102 may generate a trigger event that indicates a completion of the execution of the primary task. The electronic device 102 may further collect information, from the second worker device 108B, indicative of the completion of execution of the primary task. The second worker device 108B may receive an input indicative of completion of the primary task from the second worker 116B. For example, the electronic device 102 may determine whether the battery unit of the vehicle 106 is fully charged, based on the collection of the operational information from the vehicle 106 and/or a collection of the information indicative of the completion of the execution of the primary task from the second worker device 108B. The trigger event may be generated when the battery unit is fully charged or when the battery unit is charged up to a level (e.g., 80%). The level may be set based on a user preference or a total amount (e.g., in US Dollar) that the user may have agreed to pay for the task (e.g., the charging of the vehicle 106). Details pertaining to the generation of trigger event that indicates completion of execution of the primary task are further provided, for example, in FIGS. 4, 5A, 5B, 6A, and 6B.

The electronic device 102 may control a display device to display a status of the service request. The status may be displayed based on the collected operational information and the generated trigger event. In accordance with an embodiment, the display device may be coupled to the user device 104. The status may indicate that the primary task has been completed. For example, the electronic device 102 may control the display device to display that the battery unit of the vehicle 106 is fully charged. The status may include, for example, a timestamp of connection of the battery unit to an electric vehicle charger, a timestamp of disconnection of the battery unit from the electric vehicle charger (when the battery unit is fully charged), an amount payable for the charging of the battery unit, and the like. The control may be based on reception of information collected from the vehicle 106 and the second worker device 108B. The vehicle 106 may transmit information to the electronic device 102 that the battery unit of the vehicle 106 is fully charged. The second worker device 108B may transmit information that indicates that charging of the battery unit of the vehicle 106 is complete. Details pertaining to control of the display device to display the status of the service request are further provided, for example, in FIGS. 4, 5B, and 6B.

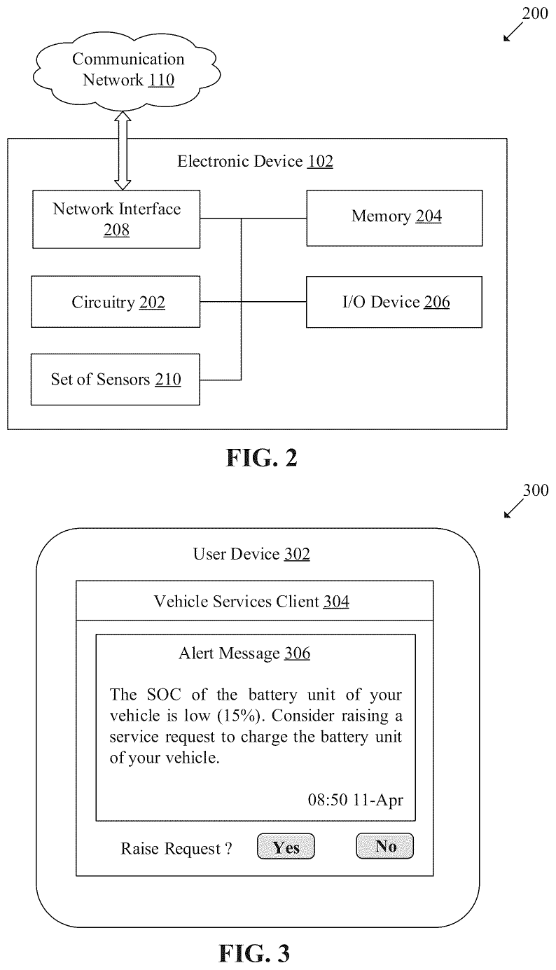

FIG. 2 is a block diagram that illustrates an exemplary electronic device that serves as a platform for management of tasks related to service requests for a vehicle, in accordance with an embodiment of the disclosure. FIG. 2 is explained in conjunction with elements from FIG. 1. With reference to FIG. 2, there is shown a block diagram 200 of the electronic device 102. The electronic device 102 may include circuitry 202, a memory 204, an input/output (I/O) device 206, and a network interface 208. The circuitry 202 may be communicatively coupled to the memory 204, the I/O device 206, and the network interface 208, through wired or wireless communication of the electronic device 102. Although in FIG. 2, it is shown that the electronic device 102 includes the circuitry 202, the memory 204, the I/O device 206, and the network interface 208; however, the disclosure may not be so limiting, and the electronic device 102 may include less or more components.

The circuitry 202 may include suitable logic, circuitry, and/or interfaces that may be configured to execute program instructions associated with different operations to be executed by the electronic device 102. The set of operations may include, but are not limited to, reception of a service request associated with the vehicle 106, determination of a location, based on the service request, where a primary task of the service request is executable, identification, based on the determined location, of a pool of workers available for a fulfilment of the service request, assignment of a first worker from the pool of workers to move the vehicle 106 from an initial location to the determined location, assignment of a second worker from the pool of workers to execute the primary task while the vehicle 106 is at the determined location, collection of operational information associated with the vehicle 106 based on the execution of the primary task, generation, based on the operational information, of a trigger event that indicates a completion of the primary task, and control of the display device to display a status of the service request. The circuitry 202 may include any suitable special-purpose or general-purpose computer, computing entity, or processing device including various computer hardware or software modules and may be configured to execute instructions stored on any applicable computer-readable storage media. For example, the circuitry 202 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. The circuitry 202 may include any number of processors configured to, individually or collectively, perform or direct performance of any number of operations of the electronic device 102, as described in the present disclosure. Examples of the circuitry 202 may include a Central Processing Unit (CPU), a Graphical Processing Unit (GPU), an x86-based processor, an x64-based processor, a Reduced Instruction Set Computing (RISC) processor, a Complex Instruction Set Computing (CISC) processor, and/or other hardware processors.

The memory 204 may include suitable logic, circuitry, interfaces, and/or code that may be configured to store the set of instructions executable by the circuitry 202. In accordance with an embodiment, the memory 204 may include the database 112 (records stored in the database 112). In accordance with an embodiment, the memory 204 may be configured to store profiles of users (for example, the user 114) and profiles of each of the workers of the set of workers 116. In accordance with an embodiment, the memory 204 may be configured to store information about type and particulars of the vehicle 106 owned by, or associated with, the user 114; reviews associated with each worker of the set of workers 116; and particulars of each worker device of the set of worker devices 108 (that may enable the circuitry 202 to send appropriate task alerts). The memory 204 may be further configured to temporarily store the status of the service request received from the user device 104. Examples of implementation of the memory 204 may include, but are not limited to, Random Access Memory (RAM), Read Only Memory (ROM), Hard Disk Drive (HDD), a Solid-State Drive (SSD), a CPU cache, and/or a Secure Digital (SD) card.

The I/O device 206 may include suitable logic, circuitry, interfaces, and/or code that may be configured to receive an input and provide an output based on the received input. The I/O device 206 may include one or more input and output devices that may communicate with different components of the electronic device 102. For example, the I/O device 206 may receive inputs that the execution of program instructions, by the circuitry 202, associated with different operations to be executed by the electronic device 102. Examples of the I/O device 206 may include, but are not limited to, a touch screen, a keyboard, a mouse, a joystick, a microphone, and a speaker.

The network interface 208 may include suitable logic, circuitry, and interfaces that may be configured to facilitate communication between the circuitry 202, the user device 104, the vehicle 106, and the set of worker devices 108, via the communication network 110. The network interface 208 may be implemented by use of various known technologies to support wired or wireless communication of the electronic device 102 with the communication network 110. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry. The network interface 208 may be configured to communicate via wireless communication with networks, such as the Internet, an Intranet, or a wireless network, such as a cellular telephone network, a wireless local area network (LAN), and a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5th Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a near field communication protocol, a wireless pear-to-pear protocol, a protocol for email, instant messaging, and a Short Message Service (SMS).

The functions or operations executed by the electronic device 102, as described in FIG. 1, may be performed by the circuitry 202. Operations executed by the circuitry 202 are described in detail, for example, in the FIGS. 3, 4, 5A, 5B, 6A, and 6B.

FIG. 3 is an exemplary scenario diagram that illustrates a user device controlled by an electronic device to display an option to transmit a service request for a vehicle, in accordance with an embodiment of the disclosure. FIG. 3 is explained in conjunction with elements from FIG. 1 and FIG. 2. With reference to FIG. 3, there is shown an exemplary scenario diagram 300. In the exemplary scenario diagram 300, there is shown a user device 302 (for example, a smartphone). The user device 302 is an exemplary implementation of the user device 104. The functionality of the user device 302 may be identical to the user device 104 of FIG. 1. The user device 302 may include a service client 304. The service client 304 may be a software installed in the user device 302 that may be managed or updated by the electronic device 102.

At any time-instant, the user device 302 may receive content (for example, an alert message 306) associated with the vehicle 106. The alert message 306 may be received from the electronic device 102. The service client 304 may be configured to display the received alert message 306 on a user interface of the service client 304. The service client 304 may be configured to receive a user input that may correspond to a service request associated with the vehicle 106. The user device 302 may be further configured to transmit the service request to the electronic device 102.

In accordance with an embodiment, the electronic device 102 may be configured to collect the operational information associated with the vehicle 106 from the vehicle 106. In some embodiments, the service client 304 may collect operational information associated with the vehicle 106 and may transmit the operational information to the electronic device 102. The operational information may include, for example, a current SOC of a battery unit of the vehicle 106, a maximum travel distance achievable at the current SOC, a current fuel level, or an operational status of a component of the vehicle 106.

Based on the collected operational information, the electronic device 102 may detect that the current SOC of the battery unit of the vehicle 106 (for example, an electric vehicle) is less than a defined threshold level. In another example, the electronic device 102 may detect a fault or a damage in at least one component (for example, steering or braking systems) as of the vehicle 106.

Based on the detection, the electronic device 102 may control the user device 302 to display an option to transmit a service request to the electronic device 102. For example, the electronic device 102 may transmit the alert message 306 to the user device 302 based on a determination that the current SOC is less than a defined threshold level. The electronic device 102 may control the service client 304 to display the alert message 306 with an option. As shown in FIG. 3, the alert message 306 may include a text that indicates to the user 114 that the SOC of the battery unit of the vehicle 106 is less than 15% (for example, the defined threshold level is 15%) and the user 114 should consider sending a service request to charge the battery unit of the vehicle 106. The alert message 306 may further include two radio buttons, viz., a ‘Yes’ button and a ‘No’ button. The service client 304 may receive a user input via one of the two radio buttons. If a user input is received via the ‘Yes’ button, the service client 304 may transmit the service request to the electronic device 102. The electronic device 102 may receive the service request which includes a primary task (for example, an operation to connect the vehicle 106 to an electric vehicle charger) and one or more secondary tasks (e.g., to move the vehicle 106 to a first location, to disconnect the electric vehicle charger once the SOC crosses a threshold SOC, or to return the vehicle 106 to a second location).

FIG. 4 is a flowchart that illustrates exemplary operations for management of tasks related to service requests for a vehicle by an electronic device, in accordance with an embodiment of the disclosure. The flowchart 800 is described in conjunction with elements from FIGS. 1, 2, and 3. With reference to FIG. 4, there is shown a flowchart 400. The operations from 402 to 418 may be implemented, for example, by the electronic device 102 of FIG. 1 or the circuitry 202 of FIG. 2. The operations of the flowchart 400 may start at 402 and proceed to 404.

At 404, a service request associated with the vehicle 106 may be received. The electronic device 102 may be configured to receive the service request. The service request may be associated with the vehicle 106 and may include a primary task and a secondary task. Each of the primary task and the secondary task may include one or more operations to be performed to fulfill the received service request. The service request may be received from the user device 104, as a response to an option displayed on the display device associated with the user device 104, as described in FIG. 3.

The service request may have to be fulfilled based on execution of the primary task and the secondary task. For example, based on the service request, the electronic device 102 may determine that a primary task includes an operation to replace a first component of the vehicle 106 (other than the battery unit of the vehicle 106) and an operation to procure a second component as a replacement. The electronic device 102 may also detect defects in the first component which necessitate the replacement of the first component. The displayed option may be part of an alert message that prompts the user 114 to replace the first component. The second component may be identical to the first component in terms of functionality and therefore, may be replaced in place of the first component of the vehicle 106 to fulfil an operational requirement of the vehicle 106.

By way of example, and not limitation, the first component to be replaced may be a discharged battery unit of the vehicle 106 and the second component to replace the first component may be a fully or partially charged battery unit. The fully or partially charged battery unit may be procured from the third location as a replacement for the discharged battery unit. In FIG. 4, the primary task of replacement of the first component with the second component is merely provided as an example and such an example should not be construed as limiting the disclosure. The present disclosure may be also applicable to other primary tasks, without a departure from the scope of the present disclosure. Example of such other tasks may include, but is not limited to, an operation to connect an EV charger to a charging unit of the vehicle 106, an operation to disconnect the EV charger from the charging unit of the vehicle 106, an operation to repair a component of the vehicle 106, an operation to report a state of charge of a battery unit of the vehicle 106, and an operation to refuel the vehicle 106.

Based on the service request, the electronic device 102 may also determine the secondary task that includes an operation to move the vehicle 106 to a vehicle service station from an initial location of the vehicle 106 and an operation to return the vehicle 106 to the initial location of the vehicle 106. The vehicle service station may be located at a first location and the initial location of the vehicle 106 may be referred to as a second location.

At 406, a location where the primary task of the service request is executable may be determined based on the service request. The electronic device 102 may be configured to determine, based on the service request, a location where the primary task of the service request is executable. The determined location may be referred to as the first location. For example, the electronic device 102 may determine a location of the vehicle service station as the first location since the primary task of replacement of the first component of the vehicle 106 may be executed at the vehicle service station.

In accordance with an embodiment, the electronic device 102 may further determine a store that is in a third location. The second component to be used as a replacement of the first component may be procured from the determined store. In accordance with an embodiment, determination of the third location may be performed based on at least one of the first location and the second location. The electronic device 102 may be configured to select the store (located at the third location), such that the third location is within a threshold distance from the first location and the second location. The selection of the store within the threshold distance may minimize at least one of: time required for a worker to reach the third location from a present location of the worker, a time required for the worker to reach the first location from the third location, a charge/fuel required for the worker to travel to the third location from the present location, and charge/fuel required for the worker to travel to the first location from the third location. If the second component is not available at any store that is within the threshold distance, then a store that is closest to the first location and the second location may be selected for procurement. The distance of such a store from the first location or the second location may be more than the threshold distance.

At 408, a pool of workers that are available for the fulfilment of the service request may be identified, based on the determined location (i.e., first location). The electronic device 102 may identify a pool of workers that are available for the fulfilment of the service request. The pool of workers may include the set of workers 116 in same or different locations and such workers are available to execute the primary task and/or the secondary task. In accordance with an embodiment, one or more workers of the pool of workers may be a robot with an end effector or a humanoid robot.

Throughout a duration of the fulfilment of the service request, availability and location of workers may change with time. Therefore, the electronic device 102 may update the pool of workers dynamically within the duration of the fulfilment of the service request, based on the availability of workers in locations that are within a defined distance from the initial location (i.e., second location) of the vehicle 106 or the determined location (i.e., first location) for the primary task. For example, the first worker 116A may be identified from amongst the pool of workers to execute the secondary task. The second task may correspond to an operation to move the vehicle 106 to the first location from the second location. The selection of the first worker 116A may be based on the location of the first worker device 108A and a skill-level (e.g., a worker who has a driving license and a 5/5 rating in driving vehicles) of the worker.

The electronic device 102 may be configured to select the first worker 116A to move the vehicle 106 to the first location if the first worker device 108A is located within the defined distance from the second location. The electronic device 102 may select the first worker 116A if an estimate of a travel-related delay for the first worker 116A in reaching the second location is lower that estimates of travel-related delays for other workers of the pool of workers in reaching the second location. The electronic device 102 may also select the first worker 116A if a travel cost associated with the first worker 116A is less compared to travel costs associated other workers of the pool. Once the first worker is identified, the status of the first worker 116A may be changed to ‘busy’ (from ‘available’). The electronic device 102 may dynamically update the pool of workers to indicate that the first worker 116A is ‘busy’ at the second location. Similarly, the second worker 1166 worker may be identified to execute the primary task that corresponds to the operation to replace the first component of the vehicle 106 with the second component at the first location. The second worker device 1086 may located within the defined distance from the first location. The third worker 116C may be identified to execute the primary task that corresponds to the operation to procure of the second component from the third location and bring the procured second component to the first location. The third worker device 108C may located within a defined distance from the third location. A fourth worker may be identified to execute the secondary task that corresponds to the operation to return the vehicle 106 to the second location after the completion of the primary task of replacement of the first component with the second component. The fourth worker device 108D may located within the defined distance from the first location.

The electronic device 102 may dynamically update the pool of workers based on identification of each of the second worker 1166, the third worker 116C, and the fourth worker 116D. Each update may indicate the second worker 116B, the third worker 116C or the fourth worker 116D as ‘busy’.

At 410, the first worker 116A, from the pool of workers, may be assigned to move the vehicle 106 from the initial location (second location) of the vehicle 106 to the determined location (first location). The electronic device 102 may assign the first worker 116A from the pool of workers to pick the vehicle 106 from the initial location (second location) and move the vehicle 106 from the (second location) to the determined location (first location).

In accordance with an embodiment, the electronic device 102 may transmit a task alert to a device associated with the first worker 116A based on the assignment. Specifically, once the first worker 116A is identified, the electronic device 102 may send the task alert to the first worker device 108A. The task alert may specify the task, such as an operation to move the vehicle 106 to the first location from the second location. Upon sending the task alert, the electronic device 102 may receive a user input from the first worker device 108A. The user input may indicate a confirmation or an acknowledgement from the first worker 116A for the task specified in the task alert.

Throughout a duration for which the first worker 116A is assigned to the task, the electronic device 102 may collect information associated with activities of the first worker 116A. The collected information associated with activities of the first worker 116A may be collected from the first worker device 108A or from sensors installed in the vehicle 106. The first worker 116A may provide a user input via the first worker device 108A. The user input may be indicative of completion of the task specified in the task alert. For the first worker 116A, the execution of the task may be referred to as an activity of the first worker 116A. The first worker device 108A may transmit a user input to indicate that the vehicle 106 has reached the first location. The electronic device 102 may dynamically update the pool of workers to indicate that the first worker 116A is ‘available’ at the first location, based on the received user input. Further, the electronic device 102 may control the display device associated with the user device 104 to display a status of the service request. The display device may be controlled based on the user input. The status may indicate that a first step involved in the fulfillment of the service request has been completed.

At 412, the second worker 1166 from the pool of workers may be assigned to execute the primary task while the vehicle 106 is at the determined location (first location). The electronic device 102 may assign the second worker 116B from the identified pool of workers to execute the primary task. In accordance with an embodiment, the electronic device 102 may transmit a task alert to a device associated with the second worker 116B, based on the assignment. Once the second worker 116B is identified, the electronic device 102 may send the task alert to the second worker device 1086. The task alert may specify the task that corresponds to the operation to replace the first component of the vehicle 106 with the procured second component at the first location. The electronic device 102 may receive a user input from the second worker device 1086. The user input may indicate a confirmation or an acknowledgement of the second worker 116B for the task specified in the task alert.

The electronic device 102 may assign the third worker 116C, from the identified pool of workers, to execute the primary task that corresponds to the operation to procure the second component. The assignment of the task of procurement of the second component may be assigned prior to the assignment of the task of replacement of the first component of the vehicle 106. Therefore, the electronic device 102 may transmit a task alert to the third worker device 108C, associated with the third worker 116C, prior to transmission of the task alert to the second worker device 108B. The task alert transmitted to the third worker device 108C may specify a task that corresponds to an operation to procure the second component as a replacement of the first product. From the third worker device 108C, the electronic device 102 may receive a user input that indicates a confirmation of procurement of the second component from the third location.

The electronic device 102 may collect information associated with activities of the third worker 116C from the third worker device 108C. The third worker 116C may provide, via the third worker device 108C, a user input indicative of a completion of the operation of procurement of the second component from the third location and a delivery of the procured second component at the first location. The third worker device 108C may transmit the user input to the electronic device 102. The electronic device 102 may dynamically update the pool of workers to indicate that the third worker 116C is ‘available’ at the first location, based on the received user input. Thereafter, the electronic device 102 may control the display device, associated with the user device 104, to display an updated status of the service request. The updated status may indicate that a second step (i.e., a procurement of the second component for the vehicle 106 and availability of the second component at the first location) involved in the fulfillment of the service request has been completed.

Once the second component is procured and delivered at the first location, the operation to replace the first component with the second component may be performed by the second worker 1166. The electronic device 102 may collect information associated with activities of the second worker 1166 from the second worker device 1086. The second worker 116B may provide, via the second worker device 108B, a user input indicative of a completion of the operation of replacement of the first component of the vehicle 106 with the procured second component. The second worker device 1086 may transmit the user input the electronic device 102. The electronic device 102 may dynamically update the pool of workers to indicate that the second worker 116B is ‘available’ at the first location, based on the received user input. Thereafter, the electronic device 102 may control the display device to display an updated status of the service request. The updated status may indicate that a third step (i.e., a replacement of the first component with the second component) involved in the fulfillment of the service request has been completed.

In certain embodiments, the operation to procure the second component and the operation to replace the first component with the second component, may be performed by more than two workers or by one single worker (i.e., the second worker 116B), without the involvement of the third worker 116C. In such cases, respective worker device(s) may transmit user inputs to the electronic device 102 upon completion of respective operations or tasks.

At 414, the operational information associated with the vehicle 106 may be collected based on the execution of the primary task. The electronic device 102 may collect operational information associated with the vehicle 106 based on the execution of the primary task. The operational information may be collected from the vehicle 106 or from sensors installed around the vehicle 106. The collected operational information from the vehicle 106 may include at least one of a current State of Charge (SOC) of a battery unit of the vehicle 106, a maximum travel distance that is achievable at the current SOC, or an operational status of a component (for example, the second component) of the vehicle 106. In accordance with an embodiment, the operational information may be received after the execution of the primary task. For example, the electronic device 102 may collect the operational status of the second component of the vehicle 106 after the execution of the primary task (i.e., a replacement of the first component with the second component).

At 416, a trigger event that indicates a completion of the execution of the primary task may be generated based on the collected operational information. The electronic device 102 may generate the trigger event. For example, the trigger event may be generated based on the operational status of the second component. The operational status may indicate that the second component is fully operational.

At 418, a display device may be controlled to display a status of the service request. The electronic device 102 may control the display device to display the status of the service request. The status may be displayed based on the collected operational information and the generated trigger event. In accordance with an embodiment, the electronic device 102 may control the user device 104 to display, on the display device, a message. The message may indicate that the first component of the vehicle 106 has been successfully replaced with the second component.

The electronic device 102 may be further configured to assign the fourth worker 116D, from the identified pool of workers, to execute the secondary task that corresponds to an operation to return the vehicle 106 at the second location. The operation to return the vehicle 106 may be assigned after the replacement of the first component with the second component. The electronic device 102 may transmit a task alert to the fourth worker device 108D, associated with the fourth worker 116D. The task alert may specify the operation to return the vehicle 106 to the second location. The electronic device 102 may receive a user input from the fourth worker device 108D. The user input may indicate acceptance of the fourth worker 116D for the task specified in the received task alert.

Throughout a duration for which the fourth worker 116D is assigned to the task, the electronic device 102 may collect information associated with activities of the fourth worker 116D from the fourth worker device 108D or from sensors installed in the vehicle 106 or in infrastructure surrounding the vehicle 106. The fourth worker 116D may provide a user input, via the fourth worker device 108D, to indicate a completion of the operation of returning the vehicle 106 to the second location (i.e., the initial location of the vehicle 106). The fourth worker device 108D may transmit the user input to the electronic device 102. Upon reception of the input, the electronic device 102 may dynamically update the pool of workers to indicate that the fourth worker 116D is ‘available’ at the second location. Thereafter, the electronic device 102 may control the display device to display an updated status of the service request. The updated status may indicate that the final step (i.e., an operation to return the vehicle 106 to the second location) is complete and the service request is fulfilled.

It should be noted that the number of workers that are assigned for the primary task and the secondary task merely is an example and such an example should not be construed as limiting the disclosure. The present disclosure may be also applicable to assignment of more than three workers or less than three workers for the primary task and the secondary task, without a departure from the scope of the present disclosure. The assignment may depend on one or more factors, such as availability of workers in a location or area, skillsets of the workers, a budget for fulfilment of the service request, an expected duration of fulfilment of the service request, and a type or a complexity (e.g., in terms of worker hours and a number of operations to be performed to complete a single task of the service request) of tasks in the service request.

Although the flowchart 400 is illustrated as discrete operations, such as 404, 406, 408, 410, 412, 414, 416, and 418, the disclosure is not so limited. Accordingly, in certain embodiments, such discrete operations may be further divided into additional operations, combined into fewer operations, or eliminated, depending on the particular implementation without detracting from the essence of the disclosed embodiments.

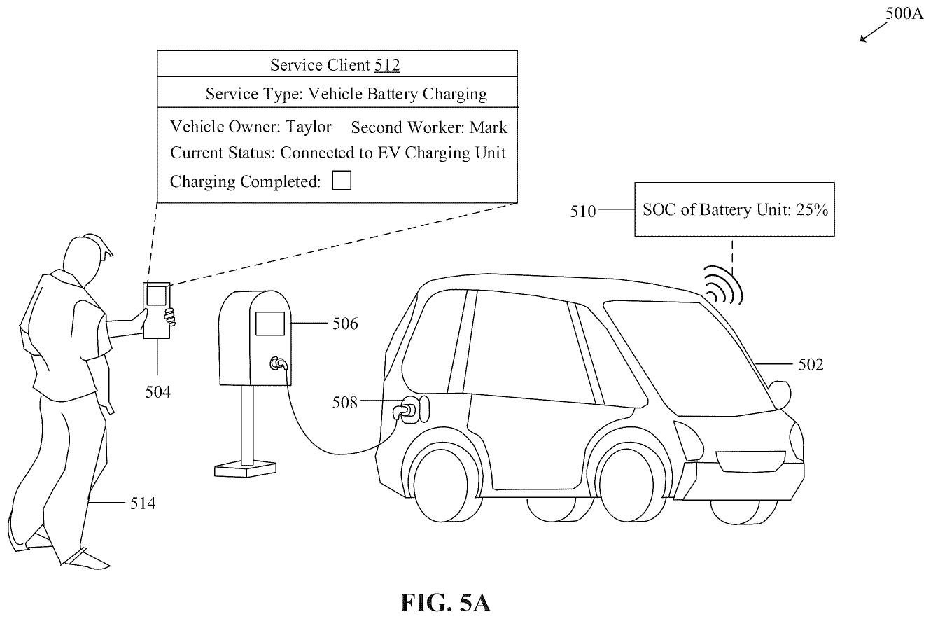

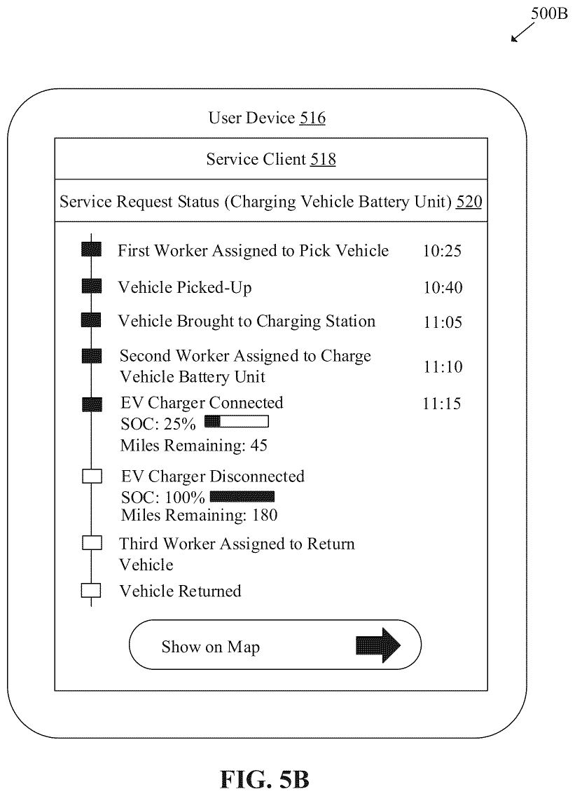

FIG. 5A is an exemplary scenario diagram that illustrates a transmission of status of a service request associated with charging of a battery unit of an electric vehicle, in accordance with an embodiment of the disclosure. FIG. 5A is explained in conjunction with elements from FIG. 1, FIG. 2, FIG. 3, and FIG. 4. With reference to FIG. 5A, there is shown an exemplary scenario 500A. The exemplary scenario 500A may include a vehicle 502, a worker device 504, an electric vehicle charger 506, and a charging unit 508. The vehicle 502 is an exemplary implement of the vehicle 106. The functionality of the vehicle 502 may be identical to the vehicle 106 shown in FIG. 1. The vehicle 502 is shown as an example implementation of an electric vehicle. The worker device 504 is an exemplary implementation of a worker device of the set of worker devices 108. The functionality of the worker device 504 may be identical to the worker device of the set of worker devices 108.

The charging unit 508 of the vehicle 106 may facilitate transfer of charge from the electric vehicle charger 506 to a battery unit of the vehicle 502. The vehicle 502 may be configured to transfer operational information 510 (for example, a SOC of the battery unit of the vehicle 502) to the electronic device 102. The worker device 504 may include a service client 512. The service client 512 may be a software installed on the worker device 504 that, when executed by the worker device 504, may transmit information associated with activities of a worker who uses the worker device 504 to the electronic device 102. There is further shown a worker 514 who may control the worker device 504. In accordance with an embodiment, the service client 512 may provide an interface to the worker 514 to provide necessary credentials associated with the worker 514. The worker 514 may receive access to use the service client 512 based on the credentials provided to the service client 512. The service client 512 may receive user inputs, from the worker 514, indicative of availability of the worker 514 for assignment of tasks. The worker device 504 may transmit information associated with activities of the worker 514 to the electronic device 102, via the service client 512.

In accordance with an embodiment, the electronic device 102 may identify the worker 514 based on availability of the worker 514 for fulfillment of a received service request associated with the vehicle 502. The service request may indicate a request to charge the battery unit of the vehicle 502. The electronic device 102 may determine a location where the battery unit of the vehicle 502 may be charged. The electronic device 102 may also determine an electric vehicle charging station at the determined location and whether there is availability of a parking space for the vehicle 502 near the electric vehicle charging station. The electronic device 102 may assign a worker, who may be different from the worker 514, to execute a task that includes an operation to move the vehicle 502 to the electric vehicle charging station at the determined location. The electronic device 102 of the electronic device 102 may also assign the worker 514 to execute a primary task at the determined location. The primary task may include an operation to connect the electric vehicle charger 506 to the charging unit 508 of the vehicle 502 and an operation to disconnect the electric vehicle charger 506 from the charging unit 508 of the vehicle 502 upon completion of the charging.

In accordance with an embodiment, the electronic device 102 may receive a user input from the worker device 504 based on a completion of the operation to connect the electric vehicle charger 506 to the charging unit 508 of the vehicle 502. The user input may indicate a current status of the service request. From the vehicle 502, the electronic device 102 may further receive operational information 510 associated with the vehicle 502. The reception may be performed based on a connection of the electric vehicle charger 506 to the charging unit 508 of the vehicle 502. The operational information 510 may indicate the current SOC (for example, 25%) of the battery unit of the vehicle 502.

FIG. 5B is an exemplary scenario diagram that illustrates display of stepwise status of a service request associated with charging of a battery unit of an electric vehicle, in accordance with an embodiment of the disclosure. FIG. 5B is explained in conjunction with elements from FIG. 1, FIG. 2, FIG. 3, FIG. 4, and FIG. 5A. With reference to FIG. 5B, there is shown an exemplary scenario 500B. The exemplary scenario 500B may include a user device 516. The user device 516 is an exemplary implement of the user device 104. The functionality of the user device 516 may be identical to the user device 104 shown in FIG. 1. The user device 516 may include a service client 518. The service client 518 may be identical to the service client 304 of FIG. 3. The user device 516 may receive content (for example, a service request status 520) associated with the vehicle 502. The service request status 520 may correspond to a stepwise status of the service request. The service client 518 may display the service request status 520 on a user interface of the service client 518.

In accordance with an embodiment, the electronic device 102 may control the service client 518 to display the service request status 520. The service request status 520 may indicate a stepwise status of a set of operations, where each step may correspond to an operation of the set of operations. The stepwise status may indicate operations that have been completed and operations that may be pending. The primary task may include the operations to connect the electric vehicle charger 506 to the charging unit 508 of the vehicle 502 and disconnect the electric vehicle charger 506 from the charging unit 508 of the vehicle 502. The secondary task may include remaining operations of the set of operations. The electronic device 102 may control the service client 518 to update the service request status 520 (e.g., EV Charger Connected or EV Charger Disconnected) via display of a timestamp associated with completion of each operation of the set of operations.

The electronic device 102 may update the stepwise status on the user interface of the service client 518, based on updates included in the operational information 510 (such as the current SOC of the battery unit of the vehicle 502) and the user input received from the worker device 504. The electronic device 102 may control the service client 518 to display information associated with the operations which correspond to the primary task. The displayed information may be updated based on the collected operational information 510. As the battery unit of the vehicle 502 receives the charge, the electronic device 102 may collect updated operational information. For example, when the electric vehicle charger 506 is connected to the charging unit 508 (at timestamp 11:15 hrs.), the collected operational information (from the vehicle 502) may indicate that the current SOC of the battery unit is 25% and the maximum travel distance achievable at the current SOC is 45 miles. Similarly, when the electric vehicle charger 506 is disconnected from the charging unit 508, the collected operational information may indicate that the current SOC of the battery unit is 100% and the maximum travel distance achievable at the current SOC is 180 miles (i.e., an estimate of mileage when the battery unit of the vehicle 106 is fully charged).

As shown in FIG. 5B, the stepwise status indicates that at 10:25, a first worker is assigned to pick the vehicle 502 from an initial location of the vehicle 502. At 10:40, the first worker picked-up the vehicle 502 from the initial location. At 11:05, the first worker brought the vehicle 502 at the determined location where the primary task of the service request is executable. The determined location may be the location of the electric vehicle charging station that houses the electric vehicle charger 506. At 11:10, a second worker (the worker 514) may be assigned to execute the primary task (for example, to charge the (vehicle) battery unit) at the vehicle charging station. At 11:15, the second worker (the worker 514) connects the charging unit 508 to the electric vehicle charger 506. The stepwise status may further indicate operations that are yet to be completed for fulfillment of the service request. In accordance with an embodiment, the electronic device 102 may control the service client 518 to display the service request status 520 on a map.

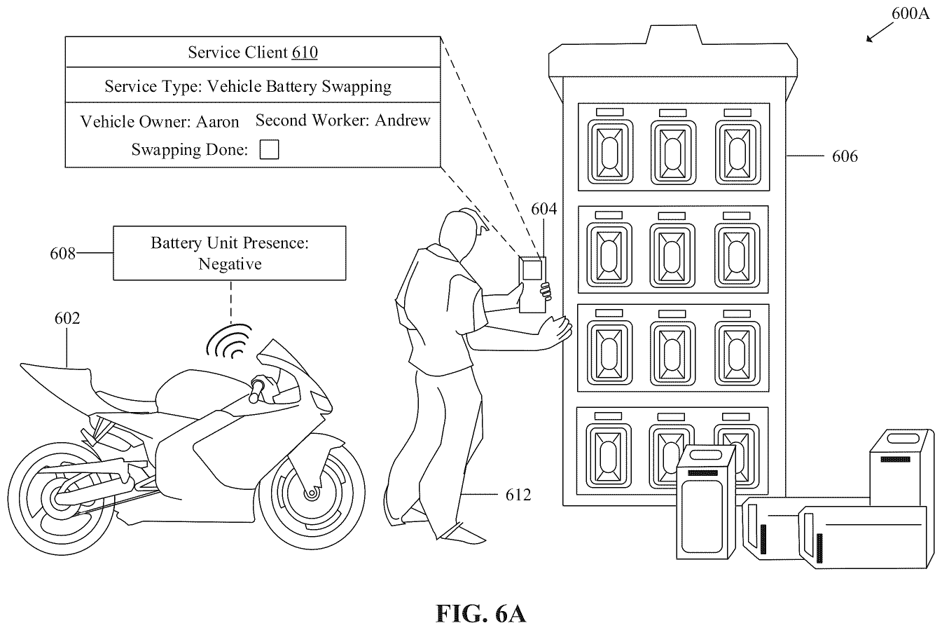

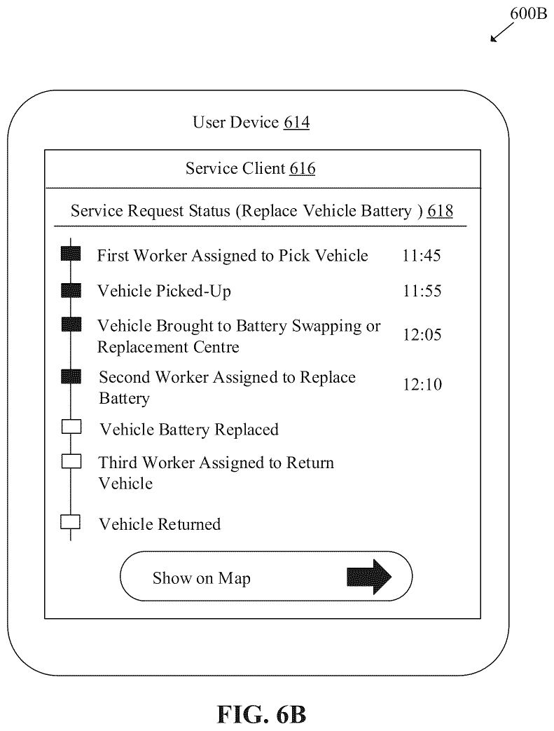

FIG. 6A is an exemplary scenario diagram that illustrates transmission of status of a service request associated with swapping or replacing a discharged battery unit of an electric vehicle, in accordance with an embodiment of the disclosure. FIG. 6A is explained in conjunction with elements from FIG. 1, FIG. 2, FIG. 3, FIG. 4, FIG. 5A, and FIG. 5B. With reference to FIG. 6A, there is shown an exemplary scenario 600A. With reference to FIG. 6A, there is shown an exemplary scenario 600A. The exemplary scenario 600A may include a vehicle 602, a worker device 604, and a battery rack 606. The vehicle 602 is an exemplary implement of the vehicle 106. The functionality of the vehicle 602 may be identical to the vehicle 106 shown in FIG. 1. The vehicle 602 may be an electric bike. The worker device 604 is an exemplary implement of a worker device of the set of worker devices 108. The functionality of the worker device 604 may be identical to the worker device of the set of worker devices 108.

The battery rack 606 may include charged battery units, a subset of which may be ready for installation in place of discharged battery units. The vehicle 602 may be configured to transfer operational information 608 (for example, an indication that the battery unit is not charged fully or is not present in the vehicle 602) to the electronic device 102.

The worker device 604 may include a service client 610. The service client 610 may be a software installed in the worker device 604 that may be configured to transmit to the electronic device 102, information associated with activities of a worker controlling the worker device 604. There is shown a worker 612 who may control the worker device 604. The information associated with activities may be transmitted via the services client 610. The service client 610 may provide an interface to the worker 612 to provide necessary credentials associated with the worker 612. The worker 612 may receive access to use the service client 610 based on the credentials provided to the service client 610. The service client 610 may receive user inputs of the worker 612 which indicate an availability of the worker 612 for assignment of tasks.

In accordance with an embodiment, the electronic device 102 may be configured to identify the worker 612. The identification may be based on availability of the worker 612 for fulfillment of a received service request to replace a discharged battery unit of the vehicle 602 with a fully or partially charged battery unit. The electronic device 102 may determine a location where the discharged battery unit of the vehicle 602 may be replaced or swapped with the fully charged battery unit. The electronic device 102 may also determine a battery replacement center, at the determined location, where the discharged battery unit of the vehicle 602 may be replaced or swapped with a charged battery unit. The vehicle 602 may be moved to the battery replacement center at the determined location. The electronic device 102 may assign the worker 612 to execute a primary task at the determined location. The primary task may include an operation to replace or swap the discharged battery unit of the vehicle 602 with a fully charged battery unit.

In accordance with an embodiment, the electronic device 102 may receive a user input from the worker device 604 based on removal of the discharged battery unit from the vehicle 602. The user input may correspond to a current status of the service request. The vehicle 602 may be configured to transmit the operational information 608 that indicates that the discharged battery unit has been removed and currently there is no battery unit in the vehicle 602.

FIG. 6B is an exemplary scenario diagram that illustrates display of stepwise status of a service request associated with swapping or replacing a discharged battery unit of an electric vehicle, in accordance with an embodiment of the disclosure. FIG. 6B is explained in conjunction with elements from FIG. 1, FIG. 2, FIG. 3, FIG. 4, FIG. 5A, FIG. 5B, and FIG. 6A. With reference to FIG. 6B, there is shown an exemplary scenario 600B. The exemplary scenario 600B may include a user device 614. The user device 614 is an exemplary implement of the user device 104. The functionality of the user device 614 may be identical to the user device 104 shown in FIG. 1. The user device 614 may include a service client 616. The service client 616 may be identical to the service client 304 of FIG. 3. The user device 614 may be configured to receive content (for example, a service request status 618) associated with the vehicle 602. The service request status 618 may correspond to a stepwise status of the service request for replacement of the discharged battery unit of the vehicle 602. The service client 616 may display the service request status 618 on a user interface of the service client 616.

In accordance with an embodiment, the electronic device 102 may control the service client 616 to display the service request status 618. The service request status 520 may indicate a stepwise status of a set of operations, where each step may correspond to an operation of the set of operations. The primary task may include the operation to replace the discharged battery unit of the vehicle 602. The service request status 618 may indicate that the discharged battery unit has been replaced (for example, Vehicle Battery Replaced) via removal of the discharged battery unit and insertion of a fully charged battery unit obtained from the battery rack 606. The secondary task may include the remaining operations of the set of operations. The electronic device 102 may control the service client 616 to update the service request status 618 via display of a timestamp associated with completion of each operation of the set of operations.

The electronic device 102 may be configured to update the stepwise status based on updates in the collected operational information 608. For instance, the vehicle 602 may initially transmit the operational information 608 to the electronic device 102. The operational information 608 may indicate that battery unit is not present in the vehicle 602. Once the fully charged battery unit is connected to the vehicle 602, updated operational information may be transmitted to the electronic device 102. The electronic device 102 may update the service request status 618 to indicate that the discharged battery unit has been replaced with a fully or partially charged battery unit. The update may be performed based on the updated operational information collected from the vehicle 106. The service request status 618 may also be updated based on the user input received from the worker device 604. The electronic device 102 may receive the user input when the fully charged battery unit is connected to the vehicle 602. The service client 616 may be controlled to display information associated with the task, which corresponds to the replacement of the discharged battery unit.

As shown in FIG. 6B, the stepwise status may indicate that, at 11:45, a first worker is assigned to pick the vehicle 602 from an initial location of the vehicle 602. At 11:50, the first worker picked the vehicle 602 from the initial location. At 12:05, the first worker brought the vehicle 602 at the battery replacement center. At 12:10, a second worker (the worker 612) may be assigned to execute the primary task of replacing the discharged battery unit with the fully charged battery unit obtained from the battery rack 606. The stepwise status may further indicate operations that are yet to be completed for fulfillment of the service request.

Various embodiments of the disclosure may provide a non-transitory, computer-readable medium and/or storage medium, and/or a non-transitory machine readable medium and/or storage medium stored thereon, a set of instructions executable by a machine and/or a computer (such as the electronic device 102) for platform for managing tasks related to service requests for a vehicle. The set of instructions may be executable by the machine and/or the computer to perform operations that may include reception of a service request associated with a vehicle 106. The operations may further include determination, based on the service request, a location where a primary task of the service request is executable. The primary task may be associated with an operational requirement of the vehicle 106. The operations may further include identification of a pool of workers available for fulfilment of the service request, based on the determined location. The operations may further include assignment of a first worker from the pool of workers to move the vehicle 106 from an initial location to the determined location. The operations may further include assignment of a second worker from the pool of workers to execute the primary task while the vehicle 106 is at the determined location. The operations may further include collection of operational information associated with the vehicle 106, based on the execution of the primary task. The operations may further include generation, based on the operational information, of a trigger event that indicates a completion of the primary task. The operations may further include control of a display device to display a status of the service request, wherein the status is displayed based on the collected operational information and the trigger event.

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein but may be employed in any number of applications and equivalent devices by those of ordinary skill in the art. Rather it is hereby intended the scope be defined by the claims appended hereto. Additionally, the features of various implementing embodiments may be combined to form further embodiments.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that includes a portion of an integrated circuit that also performs other functions. It may be understood that, depending on the embodiment, some of the steps described above may be eliminated, while other additional steps may be added, and the sequence of steps may be changed.

The present disclosure may also be embedded in a computer program product, which includes all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form. While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure not to be limited to the particular embodiment disclosed, but that the present disclosure will include all embodiments that fall within the scope of the appended claims.

What is claimed is:

1. An electronic device, comprising:
circuitry that:
receives a service request associated with a vehicle;
determines, based on the service request, a location where a primary task of the service request is executable,
wherein the primary task is associated with an operational requirement of the vehicle;
identifies a pool of workers that is available for a fulfilment of the service request, based on the determined location;
assigns a first worker from the pool of workers to move the vehicle from an initial location to the determined location;
assigns a second worker from the pool of workers to execute the primary task while the vehicle is at the determined location;
collects operational information associated with the vehicle, based on the execution of the primary task;
generates, based on the operational information, a trigger event that indicates a completion of the primary task; and
controls a display device to display a status of the service request, wherein the status is displayed based on the collected operational information and the trigger event.

2. The electronic device according to claim 1, wherein the primary task of the service request includes one or more of:
an operation to connect an Electric Vehicle (EV) charger to a charging unit of the vehicle,
an operation to disconnect the EV charger from the charging unit of the vehicle,
an operation to report a state of charge of a battery unit of the vehicle,
an operation to swap or replace a discharged battery unit of the vehicle with a fully charged battery unit,
an operation to replace or repair a component other than the battery unit of the vehicle,
an operation to refuel the vehicle, and
an operation to procure or purchase a material or a product for the vehicle.

3. The electronic device according to claim 1, wherein the vehicle is one of a fossil fuel-powered vehicle, an electric vehicle, or a hybrid vehicle.

4. The electronic device according to claim 1, wherein the circuitry further:
detects one or more of a State of Charge (SOC) of a battery unit of the vehicle or a defect in at least one component of the vehicle; and
controls a user device based on the detection, to display an option to transmit the service request to the electronic device.

5. The electronic device according to claim 1, wherein the circuitry further updates the pool of workers dynamically within a duration of the fulfilment of the service request, based on availability of workers in locations that are within a defined distance from the initial location of the vehicle or the determined location for the primary task.

6. The electronic device according to claim 1, wherein the circuitry further assigns a third worker from the pool of workers to return the vehicle to the initial location, based on the trigger event.

7. The electronic device according to claim 1, wherein the circuitry further:
transmits a task alert to a device associated with each of the first worker and the second worker, based on the assignment; and
receives, from the device, a user input indicative of a confirmation or acknowledgement of a task specified in the task alert.

8. The electronic device according to claim 1, wherein the circuitry further collects information associated with activities of the first worker and the second worker, wherein the status is a stepwise status of the service request that is displayed further based on the collected information associated with the activities.

9. The electronic device according to claim 1, wherein the operational information includes at least one of a current State of Charge (SOC) of a battery unit of the vehicle, a maximum travel distance that is achievable at the current SOC, or an operational status of a component of the vehicle.

10. A method, comprising:
in an electronic device:
receiving a service request associated with a vehicle;
determining, based on the service request, a location where a primary task of the service request is executable,
wherein the primary task is associated with an operational requirement of the vehicle;
identifying a pool of workers that is available for a fulfilment of the service request, based on the determined location;
assigning a first worker from the pool of workers to move the vehicle from an initial location to the determined location;
assigning a second worker from the pool of workers to execute the primary task while the vehicle is at the determined location;
collecting operational information associated with the vehicle, based on the execution of the primary task;
generating, based on the operational information, a trigger event that indicates a completion of the primary task; and
controlling a display device to display a status of the service request, wherein the status is displayed based on the collected operational information and the trigger event.

11. The method according to claim 10, wherein the primary task of the service request includes one or more of:
an operation to connect an Electric Vehicle (EV) charger to a charging unit of the vehicle,
an operation to disconnect the EV charger from the charging unit of the vehicle,
an operation to report a state of charge of a battery unit of the vehicle,
an operation to swap or replace a discharged battery unit of the vehicle with a fully charged battery unit,
an operation to replace or repair a component other than the battery unit of the vehicle,
an operation to refuel the vehicle, and
an operation to procure or purchase a material or a product for the vehicle.

12. The method according to claim 10, wherein the vehicle is one of a fossil fuel-powered vehicle, an electric vehicle, or a hybrid vehicle.

13. The method according to claim 10, further comprising:
detecting one or more of a State of Charge (SOC) of a battery unit of the vehicle or a defect in at least one component of the vehicle; and
controlling a user device based on the detection, to display an option to transmit the service request to the electronic device.

14. The method according to claim 10, further comprising updating the pool of workers dynamically within a duration of the fulfilment of the service request, based on availability of workers in locations that are within a defined distance from the initial location of the vehicle or the determined location for the primary task.

15. The method according to claim 10, further comprising assigning a third worker from the pool of workers to return the vehicle to the initial location, based on the trigger event.

16. The method according to claim 10, further comprising:
transmitting a task alert to a device associated with each of the first worker and the second worker, based on the assignment; and
receiving from the device, a user input indicative of a confirmation or acknowledgement of a task specified in the task alert.

17. The method according to claim 10, further comprising collecting information associated with activities of the first worker and the second worker, wherein the status is a stepwise status of the service request that is displayed further based on the collected information associated with the activities.

18. The method according to claim 10, wherein the operational information includes at least one of a current State of Charge (SOC) of a battery unit of the vehicle, a maximum travel distance that is achievable at the current SOC, or an operational status of a component of the vehicle.

19. A non-transitory computer-readable storage medium configured to store instructions that, in response to being executed, causes an electronic device to perform operations, the operations comprising:
receiving a service request associated with a vehicle;
determining, based on the service request, a location where a primary task of the service request is executable,
wherein the primary task is associated with an operational requirement of the vehicle;
identifying a pool of workers that is available for a fulfilment of the service request, based on the determined location;
assigning a first worker from the pool of workers to move the vehicle from an initial location to the determined location;
assigning a second worker from the pool of workers to execute the primary task while the vehicle is at the determined location;
collecting operational information associated with the vehicle, based on the execution of the primary task;
generating, based on the operational information, a trigger event that indicates a completion of the primary task; and
controlling a display device to display a status of the service request, wherein the status is displayed based on the collected operational information and the trigger event.

20. The non-transitory computer-readable storage medium according to claim 19, wherein the primary task of the service request includes one or more of:
an operation to connect an Electric Vehicle (EV) charger to a charging unit of the vehicle,
an operation to disconnect the EV charger from the charging unit of the vehicle,
an operation to report a state of charge of a battery unit of the vehicle,
an operation to swap or replace a discharged battery unit of the vehicle with a fully charged battery unit,
an operation to replace or repair a component other than the battery unit of the vehicle,
an operation to refuel the vehicle, and
an operation to procure or purchase a material or a product for the vehicle.
